(19) United States
(12) Patent Application Publication
(10) Pub. No.: US 2022/0380608 A1
(43) Pub. Date: Dec. 1, 2022

(54) Flame Retardant Mechanical Foam

(71) Applicant: Stahl International B.V., Waalwijk (NL)

(72) Inventor: Jan Marcel Maurice Terras, Kaster (BE)

(21) Appl. No.: 17/841,465

(22) Filed: Jun. 15, 2022

Related U.S. Application Data
(63) Continuation of application No. PCT/NL2020/050815, filed on Dec. 23, 2020.

(30) Foreign Application Priority Data
Dec. 23, 2019 (NL) 2024564

(51) Int. Cl. C09D 5/18; C09D 175/04; C08J 9/00; D06M 15/568

(52) U.S. Cl. CPC C09D 5/18; C09D 5/185; C09D 175/04; C08J 9/0066; D06M 15/568; C08J 2375/04; C08J 2201/026; D06M 2200/30

(57) ABSTRACT

One or more embodiments of the present invention provides a process for the preparation of a coating or layer on a substrate, in which process a mixture comprising one or more polyurethane dispersions, one or more flame retardants, which can be halogen-based or halogen-free, one or more foam stabilizers and optionally one or more crosslinkers is mechanically foamed and then applied on a substrate as a foam, optionally followed by adding flocking fibres, and subsequently dried, wherein the foam has flame retardant properties and remains present as a stable pressure resistant dried foam.

### CROSS-REFERENCE TO RELATED APPLICATIONS

This application is a continuation application of PCT/NL2020/050815, titled “FLAME RETARDANT MECHANICAL FOAM”, filed on Dec. 23, 2020, which claims priority to and the benefit of Netherland Patent Application No. 2024564, titled “FLAME RETARDANT MECHANICAL FOAM”, filed on Dec. 23, 2019, and the specification and claims thereof are incorporated herein by reference.

### BACKGROUND OF THE INVENTION

One or more embodiments of the present invention concerns a process for preparing a coating or layer on a substrate, wherein a foam is applied that is foamed by mechanical action and that has flame retardant properties.

Several methods have been developed to obtain flame retardant surfaces by using halogen containing or non-halogen containing systems. Besides the chemistry involved, also the method of application of the coating on a substrate is of influence on the flame retardant properties, wherein the method of application will have specific advantages and disadvantages. The focus of the one or more embodiments of the present invention is on substrates that are non-rigid, for example woven textiles, non-woven textiles and knits that can be used as home and decoration textiles or technical textiles, such as curtains, furniture and carpets.

One approach to obtain flame retardant surfaces is by using paste coatings, which have usually a good efficiency and adhesion to the surface. However, they are less used in textile field because of their rigid nature and the fact that chemicals can easily penetrate through them. For example, in roll curtains, which are rather rigid, these paste coatings can be and are in use.

Another approach to obtain flame retardant surfaces is by using collapsible foam, which is a preferred method for many years because it has a flexible, non-rigid nature, and allows for high production speed. The approach is mainly used for obtaining flame retardant properties of woven mattress covers and furniture according to the British standard, especially for the cigarette and flame test. The foam is produced by applying foaming agents and mechanical action, followed by drying. The foam in itself is instable and will collapse during the drying process. The collapsed foam will then be a thin coating layer, which has penetrated partly into the substrate. However, this degree of penetration is very dependent on the type of substrate. This approach often employs, in order to fulfil the flame tests, high amounts of coating, which results in more rigidity.

Yet another approach to obtain flame retardant surfaces is by using foam that has been crushed, often called crushed foam, which is generally the preferred method to fulfil the very demanding Crib 5 burning test, which employs a set of wooden planks that is placed on the test specimen and then ignited. The approach is also used for obtaining flame retardant properties of black-out and dim-out curtains. In this approach, a stable foam is applied onto a substrate, usually via knife-over-roll principle, dried at modest temperatures and then mechanically crushed by high calender pressure, followed by a post cure to enhance adhesion to the substrate. The stable foam is pressure sensitive at the stage prior to the crushing step, and therefore the crushing step is always done. Optionally flock, such as viscose fibres, is applied in, for example, furniture applications to provide a velvet like surface. In such furniture applications, the flame retardant layer is on the back side of the substrate, which should give insulating effect during the flame test, as the crib tests involves flames that last for about 4 to 5 minutes at least, between the burning substrate on the outside and the flame retardant layer, so that only the substrate at the outside burns and not the cushions behind the flame retardant layer. Disadvantages of crushed foam are the slower production speed, compared to collapsible foam, and the generally poor adhesion. To compensate for the poor adhesion, often a higher density foam is used, for example 600 g/L.

Yet another approach to obtain flame retardant surfaces is by using lamination, in which a flame retardant barrier fabric is attached behind the substrate. The flame retardant fabric can be woven, non-woven or knits textiles impregnated with flame retardants or inherently flame retardant fibres, such as, for example, Kanecaron (modacrylic fibre obtainable from Kaneka Corporation), Lenzing FR (flame-resistant cellulosic fibre obtainable from Lenzing Industrial). Disadvantages of using such an under layer of flame retardant fabric are that the total laminate structure can become too rigid and that the total laminate structure burns too intense at the outside of the laminate structure due to the limited extinguishing effect of the flame retardant layer underneath.

The approaches described above can employ halogen-based flame-retardants or non-halogen based flame-retardants.

Patent application CN 102108639 relates to a manufacturing process for a smokeless high flame retardant high-speed train seat fabric, comprising a foam coating process on the back of the fabric. It refers to foam pressure in order to monitor a controlled level of penetration into the fabric. As such, a “controlled penetration” without strike-through is obtained and the purpose is still to have the foam collapsed into the stenter frame, and a high curing temperature of 150° C. is employed.

US 10035925 discloses a composition for a car interior trim consisting of a polyurethane sponge layer onto which a water-soluble resin layer is applied, wherein the water-soluble resin layer, which may contain polyurethane dispersions and/or polyacrylic dispersions, also contains phosphorous-based flame-retardants. However, the layer wherein the flame-retardants are present is not foamed but applied as coating on a polyurethane foam layer.

AU 2017/213139 relates to flame protection foam coatings for textile sheet products, said coatings comprising at least one binder, at least one foam stabilizer and low-salt-content expandable graphite in the form of platelets as flame retardant. Due to the desalting, expandable graphite of a larger plate size can be used in the textile coating whereby the proportion of expandable graphite in the coating can be reduced while obtaining a better protective action. The expansion and flame protection produced thereby are increased by a multiple, without having adverse effects on the further properties such as water vapor permeability, breathing activity, freedom of movement and freedom of handling. Thicker intumescent layers are being produced. Red phosphorous can be added to increase the flame retardant effect, generally in an amount of 5 to 20 wt %. The amount of expandable graphite in the flame protection coating is between 5 and 50 % by weight. However, graphite is not an active flame retardant but rather provides for a barrier due to the charring behaviour. Graphite will swell when exposed to heat/flames and this results in charring. But this only provides effective flame protection if the graphite is between the flames and the substrate. If the graphite is used inside the coating at the backside of the substrate, then the graphite will not provide protection against flames at the other side of the substrate. In AU 2017/213139 graphite is being used inside the coating and hence will only provide limited flame resistance.

EP 1573119 discloses a process for making a two or more component foam composite obtained by adhesion of a polyurethane foam onto a substrate such as textile comprising the steps of frothing an aqueous polyurethane formulation, applying the froth to a substrate and drying the froth into a foam wherein the foam has a dry density of 35 to 160 kg/m³. A flame retardant is added to a polyurethane dispersion in a sufficient amount so that upon preparing a foam from such dispersion, the foam meets combustion modification test FMVSS 302. However, test FMVSS 302 is a simple horizontal flame test, which is not difficult to pass, and the patent application aims at foams of considerable thickness and with a low foam density of about 35 g/L to 160 g/L, prepared using both a frothing surfactant and a stabilizing surfactant, whereas the present invention aims at medium density foams that pass more demanding flame tests. Further the obtained foam is a resilient foam whereas the present invention concerns a pressure resistant foam.

Polyurethane foam having flame retardant properties is well known, and is in use for many years in, for example, polyurethane mattresses. However, such polyurethane foams are then generally foamed simultaneously with the reaction between isocyanate groups and hydroxyl groups during which either water or a blowing agent is employed to obtain a foam. Water reacts with isocyanate and generates carbon dioxide that is released as a gas that is capable of generating bubbles and thus foam. A recent example of a publication describing a process to obtain polyurethane foam in a reactive process is US 10377871.

### BRIEF DESCRIPTION OF THE INVENTION

One or more embodiments of the present invention solves several of the abovementioned disadvantages encountered in the prior art to obtain flame retardant woven textiles, non-woven textiles and knits.

One or more embodiments of the present invention provides a process for preparing a coating or layer on a substrate, in particular woven textiles, non-woven textiles and knits wherein a foam is applied that is foamed by mechanical stirring, which has flame retardant properties and which remains present as a stable, pressure resistant dried foam with a medium foam density of generally above 160 g/L preferably above 165 g/L, most preferably above 170 g/L.

In particular, an embodiment of the present invention provides a process for the preparation of a coating or layer on a substrate, in which process a formulation mixture comprising one or more polyurethane dispersions, one or more flame retardants, which can be halogen-based or halogen-free, one or more foam stabilizers and optionally one or more crosslinkers is mechanically foamed (i.e. by high speed stirring) and then applied on a substrate as a foam, optionally followed by adding flocking fibres, and subsequently dried, wherein the foam has flame retardant properties and remains present as a stable pressure resistant dried foam which comes back into its original shape and layer thickness after applying pressure on the cured foam (hence does not qualify as a resilient foam).

An advantage of embodiments of the present invention is that the obtained flame retardant woven textiles, non-woven textiles and knits show a very good performance in flame tests, both horizontal flame tests and vertical flame tests, as well as crib flame tests. As a result, it is possible to use less flame retardant components per surface unit, expressed, for example, as g/m², while obtaining better or similar flame retardant properties as obtained with other flame retardant layers of the prior art from paste coating, collapsible foam or crushed foam.

A further advantage of an embodiment of the present invention is that the obtained flame retardant woven textiles, non-woven textiles and knits have a pleasant and supple feel and do not feel rigid or stiff.

A further advantage of an embodiment of the present invention is that the coating or layer on the substrate can have a low weight and need only a modest concentration of flame-retardants to achieve the required flame retardant properties. Generally the loading of flame retardant per surface area can be as low as 20% to 40% of the loading of flame retardant per surface area of reference coatings or layers of the prior art. Prior art coatings typically have a loading of halogenated flame retardant per surface area of about 135 g/m², whereas the loading of flame retardants per surface area in the present invention is generally between 20 g/m² and 80 g/m², preferably between 25 g/m² and 60 g/m².

A further advantage of an embodiment of the present invention is that the curing of the foam can be achieved at modestly elevated temperatures of generally up to 120° C., whereas high drying temperatures of up to 150° C. are needed to obtain the traditional foamed layers of the prior art.

A further advantage of an embodiment of the present invention is that the foam that has been formed remains a foam after drying and can withstand mechanical pressure, which is even the case when a substantial loading of flame-retardants has been used.

A further advantage of obtaining a foam of the present invention as layer or coating on a substrate, like a textile, is that the flame retardant effect is very substantial, because the foam of the present invention is concentrated on one side of the substrate with only partial penetration, whereas with paste and crushed foam the flame retardant penetrates into the substrate more deeply and is often partially distributed throughout the substrate.

Another further advantage of a foam of the present invention as layer or coating on a substrate, like a textile, is that the foam can absorb a substantial amount of water in the water soaking procedure, as a pre-treatment, before testing according to the British furniture regulation BS 5852:2006 Annex E, which helps to pass the BS 5852:2006 burning tests. This moisture effect allows employing relatively low amount of coating weights and relatively low amounts of flame-retardants per unit of fabric surface while still achieving the flame retardant properties to pass the BS 5852:2006 tests, which results in a loading of flame retardant per surface area that can be as low as 20% to 40% of the loading of flame retardant per surface area of reference coatings or layers of the prior art.

Another further advantage of a foam of the present invention as layer or coating on a substrate, like a textile, is that the foam has a microporous structure hampering the transport of oxygen through the foam, whereas oxygen can easily transfer through the foam of traditional foaming layers of the prior art, which have larger irregular holes. A reduction of oxygen transport through the layer will limit the availability of oxygen and thus limit the maintenance or propagation of flames.

Another further advantage of an embodiment of the present invention compared to crushed foam is that the foam layer of the present invention can be applied in one process step, whereas two process steps are needed to obtain a crushed foam layer.

The formulation mixture for use in an embodiment the present invention comprising one or more polyurethane dispersions, one or more flame retardants, which can be halogen-based or halogen-free, one or more foam stabilizers and optionally one or more crosslinkers, contains the polyurethane dispersions and flame retardants typically in a ratio of polyurethane dispersion to flame retardant of between 95 parts/5 parts to 20 parts/80 parts, preferably between 80 parts/20 parts and 30 parts/70 parts, more preferably between 60 parts/40 parts and 40 parts/60 parts, where the ratio is based on weights of both of said components. The mixture generally contains between 1 part and 10 parts of the one or more foam stabilizers, and between 0 and 10 parts of the optional one or more crosslinkers based on the total formulation mixture.

The one or more polyurethane dispersions in the formulation mixture for use in an embodiment of the present invention can be any aqueous polyurethane dispersion. The aqueous polyurethane dispersions are preferably solvent-free, but may also contain some solvent or solvents. The solids level of the aqueous polyurethane dispersions is generally between 25% and 65%, preferably between 30% and 60% by weight. The aqueous polyurethane dispersions may further comprise fillers, colorants, pigments, silicones, matting agents, flow agents, plasticizers, viscosity modifiers, levelling agents, adhesion promoters, rheology modifiers, ultra-violet (UV) absorbers, hindered amine light stabilizers (HALS), biocides. An overview of properties and synthesis methods of aqueous polyurethane dispersions can be found in Chapter 14 “Waterborne Polyurethanes” in textbook ‘Szycher's Handbook of Polyurethanes’, edited by M Szycher, published 1999 by CRC Press, ISBN 0-8493-0602-7.

The one or more flame retardants in the formulation mixture for use in an embodiment of the present invention can be any flame retardant that is typically used to give enhanced flame retardant properties to a typical latex foam. Such flame retardants may be halogen-based or halogen-free. An overview of flame retardants that are used in the field of polyurethane coatings is given in Chapter 9 “Flame Retardants in Commercial Use or Advanced Development in Polyurethanes” in book “Flame Retardants for Plastics and Textiles-Practical Applications”, edited by Edward D. Weil and Sergei V. Levchik, published 2009 by Hanser Publishers, ISBN 978-1-56990-454-1. Individual flame retardants can be used as well as combinations of two or more different types of flame retardants. Examples are tris(2-chloroethyl) phosphate (TCEP), tris(1-chloro-2-propyl) phosphate (TCPP), tris(1,3-dichloro-2-propyl) phosphate (TDCP), dimethyl methylphosphonate (DMMP), triethyl phosphate (TEP), triaryl phosphates such as triphenyl phosphate, isopropylphenyl diphenyl phosphate, tricresyl phosphate and trixylenyl phosphate, ammoniumpolyphosphate (APP), stabilized red phosphorus, aluminum hydroxide (ATH), graphite flakes, diphosphates or oligomeric phosphates or phosphonates, such as Chemtura's Firemaster® 100 or Albemarle's Antiblaze® V6, pentabromodiphenyl ether, tetrabromobenzoate ester, tris(butoxyethyl) phosphate, diphenyl octyl phosphate and other diphenyl alkyl phosphates. A preferred flame retardant for use in the present invention is di-ammonium phosphate in its coated (encapsulated) form as well as its uncoated form. Preferably so-called intumescent flame retardants such as expandable graphite are not used as sole or main flame retardant in the present invention. In a preferred embodiment the use of graphite, including expandable graphite, as flame retardant is zero or limited to an amount of maximum 20% by weight of the formulation mixture, preferably maximum 10% or even 5% by weight of the formulation mixture. Flame retardant properties deteriorate when higher amounts of graphite are used showing barrier performance only, and deteriorating extinguishing behavior of back coatings to the surface of the substrate. Using low levels of graphite in an embodiment of the present invention does not contribute to the barrier or extinguishing behavior of flame retardant coatings directly, but helps to dissipate heat away from the combustion. Further one is normally reluctant to use graphite for esthetic reasons. The rubbing issue of graphite is eliminated in the current invention as the graphite is held in a three dimensional matrix.

The optional crosslinker in the formulation mixture for use in an embodiment of the present invention can be any crosslinker suitable for crosslinking polyurethane dispersions, such as polycarbodiimide crosslinker, isocyanate crosslinker, aziridine crosslinker or polyurea crosslinker, of which an aqueous polycarbodiimide crosslinker, such as XR-5577 or XR-5508 (both obtainable from Stahl Europe BV), or a 100% solids polycarbodiimide such as XR-13-554 (obtainable from Stahl Europe BV), would be preferred crosslinkers. When such a polycarbodimide crosslinker is used in an embodiment of the present invention no additional curing of the foam at high temperature after drying is needed; good mechanical properties are obtained solely by drying (generally at temperatures of between 10 and 100° C.) without the need for subsequent curing at higher temperatures. This is important when textiles are used as substrate, as many textiles may deteriorate upon exposure to high temperature. Using polycarbodiimide crosslinker, the fixation occurs upon the crosslinking reaction with polycarbodiimides, whereas in the prior art (e.g. AU 2017/21313) (and industry standards) the subsequent high temperature treatment is needed to prevent that the flame retardant components would be extracted from the foam/coating during the soaking test prior to the flame test. In prior art systems usually encapsulated/coated di-ammonium phosphate is used as flame retardant to prevent extraction during the soaking procedure. In embodiments of the present invention one can work with uncoated diammonium phosphate (which is cheaper than the coated version) especially if carbodiimide crosslinkers are being used. When such a polycarbodiimide crosslinker is used, it is generally present in an amount of between 1 and 5% by weight of the foam formulation or between 3 and 10% by weight of the weight of the polymer dispersion inside the foam formulation.

The one or more foam stabilizers in the formulation mixture for use in embodiments of the present invention can be any foam stabilizer that is capable of stabilizing foam made from polyurethane dispersions. The amount of foam stabilizer in the formulation mixture for use in the present invention can be an amount between 0.1 and 10% by weight of the foam formulation. Foam stabilizers may comprise cationic surfactants, anionic surfactants, or non-ionic surfactants. Examples of anionic surfactants include sulfonates, carboxylates, and phosphates. Examples of cationic surfactants include quaternary amines. Examples of non-ionic surfactants include silicone surfactants and block copolymers containing ethylene oxide. In addition to the surfactants described above, foam stabilizers can include, for example, sulphates, succinamates, sulphosuccinamates and stearate salts. Any foam stabilizer known to be useful by those of ordinary skill in the art of preparing polyurethane foams can be used in the present invention. Preferably one or more foam stabilizers is a carboxylic acid salt. Such surfactants can be represented by the general formula, RCO₂⁻X⁺, wherein R represents a C₈-C₂₀ linear or branched alkyl, which can contain an aromatic, a cycloaliphatic, or heterocycle; and X is a counter ion. Generally X is Na, K, or an amine, such as NH₄⁺, morpholine, ethanolamine, triethanolamine, etc. Preferably R is from 10 to 18 carbon atoms. More preferably R contains from 12-18 carbon atoms. The surfactant can contain a plurality of different R species, such as a mixture of C₈-C₂₀ alkyl salts of fatty acids. Preferably X is an amine. More preferably the surfactant is an ammonium salt, such as ammonium stearate.

The formulation mixture for use in one or more embodiments of the present invention can also contain additives that are generally used for the application, such as fillers, colorants, pigments, silicones, matting agents, flow agents, plasticizers, viscosity modifiers, levelling agents, adhesion promoters, rheology modifiers, ultra-violet (UV) absorbers, hindered amine light stabilizers (HALS), biocides, but fluorocarbons are preferably not used in the present invention or are present in very low amounts (generally below 1 wt % of the formulation). Fluorocarbons are usually added to lower moisture absorbance and tendency to swell. In an embodiment of the present invention there is no need to add such additives since the pressure resistant foam in itself has the capacity to absorb and store moisture in higher loadings. Further if additionally a carbodiimide crosslinker is used the swelling of the coating will be prevented more than can be obtained with the addition of a fluorochemical.

The foam made from said formulation mixture is generally obtained by mechanical stirring at high speeds, i.e. with the introduction of high shear forces or by expansion of a blowing gas, such as, for example, by blowing in compressed air. The mechanical preparation of the foam can be carried out using any desired mechanical stirring, mixing and dispersing techniques. Air is generally introduced thereby, but nitrogen and other gases can also be used. The foam obtained has a density that is lower than the density of the formulation mixture because the foam is filled with air or other gasses, which have a lower density. The density of the unfoamed formulation mixture can be as high as 1600 g/L due to the high density of certain flame retardant components. The density of the obtained foam is generally between 160 g/L and 1599 g/L, preferably between 165 g/L and 1500 g/L and most preferably between 170 g/L and 1250 g/L.

The formulation mixture for use in one or more embodiments of the present invention may be applied onto various substrates using various application techniques. Preferred are substrates that are non-rigid and more preferred are woven textiles, non-woven textiles or knits, which are preferably built up from fibres of cotton, polyester/cotton blends, wool, silk, flax, jute, bamboo, polyester, nylon, rayon, viscose, ramie, spandex, aramid, acrylic, thermoplastic polyurethane (TPU), thermoplastic olefins (TPO) or the like. In addition, non-textile substrates are suitable, such as synthetic leather, natural leather, finished natural leather, coated leather, coated polyvinyl chloride, coated non-woven, coated coagulated polyurethane substrates, polypropylene, polyethylene terephthalate, polyolefines, modified polyolefins or laminated structures. The substrate can be treated with dyes, colorants, pigments, UV absorbers, plasticizers, lubricants, antioxidants, flame inhibitors and the like, either before coating or thereafter, but there is a preference for such additions before coating.

Applying the foam obtained from said formulation onto the substrate may be effected by various means such as spraying, doctor blading or pouring from a container.

The foam obtained from said formulation mixture is suitably applied onto the substrate at a coating weight of between about 10 g/m² and about 1000 g/m², preferably between about 25 g/m² and about 800 g/m² and most preferably between about 40 g/m² and 500 g/m². The thickness of the foam layer generally applied onto the substrate is between 0.01 cm and 0.5 cm, preferably between 0.05 cm and 0.3 cm; part of this foam layer penetrating into the substrate and part of this foam layer remaining on top of the substrate. The thickness of the foam layer in one embodiment of the present invention is after drying and curing generally about 30% to 60% of the thickness that was originally applied onto the substrate, which means that the foam layer retains a substantial part of its original thickness during the drying and curing steps, at least a much more substantial part of its original thickness than is the case with crushed foam of the prior art.

Optionally, the foam layer is flocked prior to the drying and curing step. In a typical flocking process, short staple fibres are applied perpendicularly to the surface utilizing an electrical field. The resulting flocked articles are characterized by a fabric-like surface of relatively low friction. Flock may be a fibre, generally with a length of between about 0.01 cm and about 0.5 cm and a diameter of between about 10 micron and about 100 micron. Flock of different colours may be prepared from a variety of different synthetic and natural fibres such as polyamides, polyesters, cotton, and rayon.

Drying and curing is preferably effected by subjecting the substrate with the applied foam layer to an elevated temperature. It is generally desirable to select a drying/curing temperature at which the foam will cure to a tack-free state within about 30 minutes, preferably between about 2 minutes and about 10 minutes. A preferred temperature range is between 60° C. and 170° C., especially between 80° C. and 150° C., and a most preferred drying/curing step is by first subjecting to a modest elevated temperature, for example between 10° C. and 100° C., preferably between 60 and 100° C., followed by subjecting to a somewhat higher temperature, for example between 100° C. and 120° C. In case a polycarbodiimide crosslinker is used it is generally sufficient to dry/cure at the modest elevated temperature only without the need for a subsequent further curing at a higher temperature. Drying/curing is conveniently performed by passing the substrate provided with the foam layer through an oven at a rate that provides the desired time at the elevated drying/curing temperature. A heated conveyor belt may be used to provide the heating required for the cure. The substrate may be heated somewhat, such as from 60° C. to 100° C., prior to being contacted with the foam, so that the substrate does not withdraw heat from the foam that would prolong or prevent its cure.

The foam on the substrate obtained according to the process of an embodiment of the invention is elastic as well as resistant to pressure, which means that upon applying pressure on the foam layer the foam layer regains almost all of its original thickness when said pressure is removed.

The coated substrate obtained by the process of the invention displays good flame retardant properties. In the context of the present invention ‘flame retardant properties’ is a general term that can encompass ignitability, ease of extinguishment, rate of flame spread, rate of heat release, and smoke formation, distinguishable features of material response to fire. Various flammability and smoke tests are known and they are performed on representative samples or on an assembled product. Improvements in flammability are sometimes accompanied by worse smoke generation. Of course, tests can only give an assessment for a particular fire risk scenario and cannot reliably predict performance in a real fire. Samples foam coated substrate obtained according to the process of the invention, perform well, and pass according to the requirements of the tests, in tests that are specific to upholstered furniture, according to British Standard BS 5852:2006, and in tests that are specific for fabrics in aviation, according to FAR 25.853.

BS 5852:2006 is a set of flame tests with various size open-flame ignition sources using wooden block assemblies, of which the ‘crib 5’ is a severe test. According to the British furniture regulation, all interliners and cover fabrics that have been treated with a flame retardant shall go through a water soaking procedure in accordance with BS5852:2006 Annex E, as a pre-treatment, before testing, followed by line drying. In principle, the soaking procedure makes the test more severe because flame-retardants can be washed out during the soaking step.

The BS 5852:2006 Crib 5 test on a cover fabric is performed in a test cabinet with a calibrated airflow. The cover fabric and the filling are put in a test rig to create a small sofa with a 90° angle between seat and back. The filling material is a combustion modified polyurethane foam. In the context of the present invention, the cover fabric is foam coated substrate obtained according to the process of the invention. The ignition sources are located in the junction between seat and back. Ignition source 5 is a wooden crib composed of 20 wooden sticks, glued together and with a total weight of 17 g. After adding propane-diol, the crib is placed on the test rig and ignited with a match. The test assembly is not allowed to smoulder for more than 60 minutes from the start of the test. The test assembly is not allowed to show evidence of charring more than 100 mm in any direction apart from upwards from the ignition source. No flaming is allowed to continue for more than 10 minutes after start of the test with ignition source 5.

BS 5852:2006 also provides for a test involving cigarette ignition, which is then BS 5852:2006 part 1. A smaller test rig is used and a standard polyurethane foam is used as filling material, compared to the Crib 5 test. The test assembly is subjected to a gas flame equivalent to a match flame for 20 seconds. No flaming is allowed to continue for more than 120 seconds after removal of the burner tube and the test assembly is not allowed to smoulder after one hour from the beginning of the test.

Aviation burning test according to FAR 25.853 takes place in a specified test chamber in which the specimen is mounted vertically. The centre of the bottom edge of the specimen is exposed to a gas flame for 12 or 60 seconds depending on the type of product. The after burn time (ABT) and burn length (BL) is recorded. According to the FAR 25.853 test method no specimen of a series may have a burn length that is 203 mm or longer and the ABT should be no longer than 15 seconds.

The foam coated substrate obtained according to the process of the invention is very suited for the water soaking procedure, as a pre-treatment, before testing according to the British furniture regulation BS 5852:2006 Annex E, because the foam can absorb a substantial amount of water and will, after the line drying, still contain absorbed water when the burning tests are done, while touching the foam gives the impression that it is dry instead of wet. The absorbed water that remains in the foam will have a beneficial effect during the BS 5852:2006 tests, because heat is absorbed for the evaporation of the water that was absorbed in the foam and this heat absorption has the effect that the flame propagation is hampered during the time in which the absorbed water evaporates. Adjusting the density of the foam and the applied thickness of the foam can be used to steer the capacity of water absorption. This moisture effect allows employing relatively low amount of coating weights and relatively low amounts of flame-retardants per unit of fabric surface while still achieving the flame retardant properties to pass the BS 5852:2006 tests.

The present invention will be further elaborated by the following non-limiting working examples, executed according to procedures known in the art. It goes without saying that many other embodiments are possible, all within the protective scope of the invention.

### DETAILED DESCRIPTION OF THE INVENTION

### EXAMPLES

Example 1: Aviation Test Method—Comparison with Paste Coating.

A mixture of 50 parts of Permutex RU-92-213 (a polyurethane dispersion, obtainable from Stahl Europe BV), 50 parts of Eagleban FRC-0387 (a product containing uncoated di-ammonium hydrogen phosphate as flame retardant, obtainable from Stahl Europe BV), 7 parts of a 30% solution of ammonium stearate in water and 1 part of Permutex XR-13-554 (a polycarbodiimide crosslinker, obtainable from Stahl Europe BV) was made. The mixture was mechanically foamed and the resulting foam was applied on an aviation fabric (produced with hydro-entanglement and fibres). The foam was subsequently dried at 80° C. during 4 minutes and, to speed up the drying, then at 120° C. during 2 minutes.

As reference, a paste containing Eagleban FRC-0387 (a product containing di-ammonium hydrogen phosphate as flame retardant, obtainable from Stahl Europe BV) was used. The reference was applied on an aviation fabric (produced with hydro-entanglement and fibres). The paste was subsequently dried at 80° C. during 4 minutes and then at 120° C. during 2 minutes.

Specimens of both samples were multiple times subjected to an aviation burning test according to FAR 25.853. The test takes place in a specified test chamber in which the specimen is mounted vertically. The centre of the bottom edge of the specimen is exposed to a gas flame for 12 seconds. The after burn time (ABT) and burn length (BL) is recorded.

The results table displays also the layer thickness that was applied, as g/m² of wet material. The g/m² of FRC-0387 that was thus applied was calculated from the g/m² of wet material and the concentration in the wet material. The concentration of FRC-0387 in the foam wet material is 46%, whereas in the paste wet material it is 100%.

| | | ABT | BL | |
|---|---|---|---|---|
| specimen | g/m² | (sec) | (cm) | g/m² of FRC-0387 |
| Foam - specimen 1 | 56 | 14 | 11 | 25.8 |
| Foam - specimen 2 | 52 | 4 | 4 | 23.9 |
| Foam - specimen 3 | 48 | 13 | 8 | 22.1 |
| Foam - specimen 4 | 56 | 4 | 3.5 | 25.8 |
| Foam - specimen 5 | 60 | 15 | 7 | 27.6 |
| Foam - specimen 6 | 58 | 11 | 5 | 26.7 |
| Average Foam | 55 | 10.2 | 6.4 | 25.3 |
| Paste - specimen 1 | 86 | 14 | 1.5 | 77.4 |
| Paste - specimen 2 | 88 | 19 | 3.2 | 79.2 |
| Paste - specimen 3 | 102 | 17 | 4 | 91.8 |
| Paste - specimen 4 | 94 | 17 | 4.5 | 84.6 |
| Paste - specimen 5 | | 20 | 2.6 | |
| Paste - specimen 6 | | 19 | 2.7 | |
| Paste - specimen 7 | | 13 | 2.7 | |
| Paste - specimen 8 | | 17 | 2.8 | |
| Average Paste | | 17.0 | 3.0 | |

The average burn time (ABT) of the foam specimens was on average 10.2 seconds, whereas for the paste specimens the average was 17.0 seconds. According to the FAR 25.853 test method, all specimens of a series must have a burn length that is 20.3 cm or less, and an after burn time of 15 seconds or shorter. Therefore, the foam specimens pass the test, whereas the paste specimens fail. The foam specimens carry a lower amount of flame retardant per surface area than the paste specimens, and still the foam specimens give a much better performance in the FAR 25.853 test.

Example 2: Upholstery Test Method—Comparison with Collapsible Foam

A mixture of 50 parts of Permutex RU-92-213 (a polyurethane dispersion, obtainable from Stahl Europe BV), 50 parts of Eagleban FRC-0387 (a product containing uncoated di-ammonium hydrogen phosphate as flame retardant, obtainable from Stahl Europe BV), 7 parts of a 30% solution of ammonium stearate in water was made. The mixture was mechanically foamed by mixing at high speed with a stirrer to a density of 200 g/L, and the resulting foam was applied on a 100% polyester-based velour textile, in a layer thickness to achieve a dried layer quantity of 100 g/m². The foam was subsequently dried at 80° C. during 4 minutes and, to speed up the drying, then at 110° C. for 2 minutes. Permutex RU-92-213 has a solids content of 60%. Eagleban FRC-0387 has a solids content of 52.5%, of which 7.5% is a polymeric resin and 45% is from fillers, including the flame retardant component(s). The mixture of 50 parts Permutex RU-92-213 and 50 parts Eagleban FRC-0387 thus contains 56 parts of solids, of which 22.5 parts are from the fillers in Eagleban FRC-0387. Thus, the percentage of these fillers, in which the flame retardant component(s) are included, in the dried coating was 40%.

As reference, a mixture was made of 30 parts of Permutex RU-92-213 (a polyurethane dispersion, obtainable from Stahl Europe BV) and 70 parts of Eagleban FRC-0387 (a product containing di-ammonium hydrogen phosphate as flame retardant, obtainable from Stahl Europe BV). The mixture was foamed to a density of 200 g/L and the resulting collapsible foam was applied on a 100% polyester-based velour textile, in a layer thickness to achieve a dried layer quantity of 100 g/m². The foam was subsequently dried at 80° C. during 4 minutes and then at 110° C. for 2 minutes, upon which the foam collapsed. Permutex RU-92-213 has a solids content of 60%. Eagleban FRC-0387 has a solids content of 52.5%, of which 7.5% is a polymeric resin and 45% is from fillers, including the flame retardant component(s). The mixture of 30 parts Permutex RU-92-213 and 70 parts Eagleban FRC-0387 thus contains 55 parts of solids, of which 31.5 parts are from the fillers in Eagleban FRC-0387. Thus, the percentage of these fillers, in which the flame retardant component(s) are included, in the dried coating was 57%.

Specimens of both samples were subjected to an upholstery burning test according to BS 5852 match test. In this test method, a test rig is constructed in order to simulate a chair with the fabric to be tested. A simulated match burner is lit, held along the crevice of the test rig for 20 seconds and then removed. No flaming is allowed to continue for more than 120 seconds after removal of the burner tube and the test assembly is not allowed to smoulder after one hour from the beginning of the test.

The specimen of the foam sample passed the test, whereas the reference specimen of the collapsible foam failed the test, while the dried layer quantity was the same for both but the amount of fillers, in which the flame retardant component(s) are included, in the dried coating was 40% in the foam sample and 57% in the reference sample.

Example 3: Upholstery Test Method—Comparison with Collapsible Foam

A mixture of 50 parts of Permutex RU-92-213 (a polyurethane dispersion, obtainable from Stahl Europe BV), 50 parts of Eagleban FRC-0387 (a product containing uncoated di-ammonium hydrogen phosphate as flame retardant, obtainable from Stahl Europe BV), 7 parts of a 30% solution of ammonium stearate in water and 1 part of Permutex XR-13-554 (a polycarbodiimide crosslinker, obtainable from Stahl Europe BV) was made. The mixture was mechanically foamed to a density of 200 g/L, and the resulting foam was applied on a 100% polyester-based textile, in a layer thickness of 0.95 mm using a knife blade. The foam was subsequently dried at 80° C. during 4 minutes and, to speed up the drying, subsequently at 120° C. during 2 minutes. Permutex RU-92-213 has a solids content of 60%. Permutex XR-13-554 has a solids content of 100%. Eagleban FRC-0387 has a solids content of 52.5%, of which 7.5% is a polymeric resin and 45% is from fillers, including the flame retardant component(s). The mixture of 50 parts Permutex RU-92-213, 50 parts Eagleban FRC-0387 and 7 parts of a 30% solution of ammonium stearate in water thus contains 59 parts of solids, of which 22.5 parts are from the fillers in Eagleban FRC-0387. Thus, the percentage of these fillers, in which the flame retardant component(s) are included, in the dried coating is 38%. A thickness of 0.95 mm, a foam density of 200 g/L and a solids content of the mixture of 59% resulted in a dried layer quantity of 112 g/m². The contribution of these fillers, in which the flame retardant component(s) are included, in the dried coating was thus 43 g/m².

Specimen of the sample was subjected to an upholstery burning test according to BS 5852 Crib 5 test. As stipulated in BS 5852, all specimens underwent a water soaking procedure in accordance with BS5852:2006 Annex E, as a pre-treatment, before testing, followed by line drying. The BS 5852:2006 Crib 5 test on a cover fabric is performed in a test cabinet with a calibrated airflow. The cover fabric and the filling are put in a test rig to create a small sofa with a 90° angle between seat and back. The filling material is a combustion modified polyurethane foam. The ignition source is located in the junction between seat and back. Ignition source 5 is a wooden crib composed of 20 wooden sticks, glued together and with a total weight of 17 g. After adding propane-diol, the crib is placed on the test rig and ignited with a match. The test assembly is not allowed to smoulder for more than 60 minutes from the start of the test. The test assembly is not allowed to show evidence of charring more than 100 mm in any direction apart from upwards from the ignition source. No flaming is allowed to continue for more than 10 minutes after start of the test with ignition source 5.

The specimen of the foam sample passed the test, as the flaming stopped after 6 minutes and charring was only 30 mm, which is well within the limits of 10 minutes and 100 mm, respectively.

Specimen of the reference also passed the test, wherein the reference was made from a brominated system, which was applied with a dried layer quantity of 150 g/m², and in the brominated system about 90% of the solids was from the flame retardant components. The contribution of the flame retardant components in the dried coating was thus 135 g/m².

The specimen of the foam sample and the specimen of the reference passed the test, while the amount of fillers, in which the flame retardant component(s) are included, in the dried coating of the foam sample was only 43 g/m², whereas the contribution of the flame retardant components in the dried coating was 135 g/m² in the reference sample.

Example 4: Upholstery Test Method—Water Uptake

Two specimen, prepared as described in Example 3, on two different fabrics were subjected to a water soaking test, as the test according to BS 5852:2006, all interliners and cover fabrics that have been treated with a flame retardant shall go through a water soaking procedure in accordance with BS5852:2006 Annex E, as a pre-treatment, before testing, followed by line drying. Pieces of 26 by 76 cm of the specimens were immersed for 30 minutes in water of 40° C., where the amount of water was 20 times the weight of the specimens. The specimens and the fabrics themselves were soaked and dried. The moisture uptake of the coating layer was calculated by subtracting the moisture uptake of the fabric from the moisture uptake of the coated fabric. The values were then calculated from grams into g/m² taking into account the surface area of the specimens.

The first specimen was constructed of a fabric of 390 g/m² and a foamed coating layer of 124 g/m². The initial moisture uptake, before drying, was 1115 g/m² for the fabric layer and 200 g/m² for the foamed coating layer. After 24 hours of line drying, the moisture uptake was 7.2 g/m² for the fabric layer and 400/m² g for the foamed coating layer. After 48 hours of line drying, the moisture uptake was 0 g/m² for the fabric layer and 74 g/m² for the foamed coating layer.

The second specimen was constructed of a fabric of 236 g/m² and a foamed coating layer of 129 g/m². The initial moisture uptake, before drying, was 493 g/m² for the fabric layer and 280 g/m² for the foamed coating layer. After 24 hours of line drying, the moisture uptake was 2.3 g/m² for the fabric layer and 28 g/m² for the foamed coating layer. After 48 hours of line drying, the moisture uptake was 0 g/m² for the fabric layer and 168 g/m² for the foamed coating layer.

The results of both specimens demonstrate that the foamed coating layer can still hold a substantial amount of moisture after 24 hours or 48 hours of line drying, which is beneficial for the BS 5852:2006 test.

Example 5: Upholstery Test Method

The procedure of Example 3 was followed, except that in addition also 10 solid parts of graphite was added as an additional flame retardant, besides the 50 parts of Eagleban FRC-0387. Specimen of the foam sample passed the BS 5852 Crib 5 test, as the flaming stopped after 5 minutes and the charring length was only 30 mm, which is well within the limits of 10 minutes and 100 mm, respectively. However the results were not improved vis-à-vis Example 3 wherein no graphite was used. Hence the foam of the present invention shows excellent barrier properties for crib 5 test, without a significant amount of graphite being present.

Example 6: Layer Thickness—Comparison with Crushed Foam

A mixture of 50 parts of Permutex RU-92-213 (a polyurethane dispersion, obtainable from Stahl Europe BV), 50 parts of Eagleban FRC-0387 (a product containing uncoated di-ammonium hydrogen phosphate as flame retardant, obtainable from Stahl Europe BV), 7 parts of a 30% solution of ammonium stearate in water and 3 parts of Permutex XR-13-554 (a polycarbodiimide crosslinker, obtainable from Stahl Europe BV) was made. The mixture was mechanically foamed to a density of 200 g/L, and the resulting foam was applied on a Leneta Card, in a layer thickness of 1 mm using a knife blade. The foam was subsequently dried at 80° C. during 3 minutes. The thickness of the Lenata Card was 0.35 mm and the thickness of the Leneta Card including the dried foam was 0.85 mm, which means that the thickness of the foam layer was 0.50 mm.

Another specimen of a dried layer of foam on Leneta Card was prepared as described above. Subsequently, a pressure of 4 bar was applied on the dried foam layer using a cyclinder. The thickness of the Lenata Card was 0.35 mm and the thickness of the Leneta Card including the dried foam was 0.85 mm, which means that the thickness of the foam layer was 0.50 mm.

As reference, a mixture of 50 parts of Permutex RA-9260 (a polyacrylic dispersion, obtainable from Stahl Europe BV), 50 parts of Eagleban FRC-0387 (a product containing uncoated diammonium phosphate as flame retardant, obtainable from Stahl Europe BV), 7 parts of a 30% solution of ammonium stearate in water and 3 parts of Permutex XR-13-554 (a polycarbodiimide crosslinker, obtainable from Stahl Europe BV) was made. The mixture was mechanically foamed to a density of 200 g/L, and the resulting foam was applied on a Leneta Card, in a layer thickness of 0.6 mm using a knife blade. The foam was subsequently dried at 80° C. during 3 minutes. A pressure of 4 bar was applied on the dried foam layer using a cyclinder to crush the foam. The thickness of the Lenata Card was 0.37 mm and the thickness of the Leneta Card including the crushed foam was 0.44 mm, which means that the thickness of the crushed foam layer was 0.07 mm. Another specimen of the reference was dried at 80° C. during 3 minutes followed by drying at 150° C. during 2 minutes. A pressure of 4 bar was applied on the dried foam layer using a cyclinder to crush the foam. The thickness of the Lenata Card was 0.37 mm and the thickness of the Leneta Card including the crushed foam was 0.46 mm, which means that the thickness of the crushed foam layer was 0.09 mm.

Note that in the specification and claims, “about” or “approximately” means within twenty percent (20%) of the numerical amount cited. The singular forms “a”, “an” and “the” are intended to include the plural forms as well, unless the context clearly indicates otherwise.

Although the invention has been described in detail with particular reference to these embodiments, other embodiments can achieve the same results. Variations and modifications of an embodiment of the present invention will be obvious to those skilled in the art and it is intended to cover in the appended claims all such modifications and equivalents. The entire disclosures of all references, applications, patents, and publications cited above are hereby incorporated by reference.

1. A process for applying a coating or layer onto a substrate, comprising the steps of:
a) providing a formulation mixture comprising:
one or more polyurethane dispersions, one or more flame retardants selected from halogen-based or halogen-free, one or more foam stabilizers;
b) mechanically foaming said mixture;
c) applying said foam onto the substrate as a foam; and
d) subsequently drying.

2. The process of claim 1 wherein the formulation mixture further comprises one or more crosslinkers.

3. The process of claim 1 further comprising adding flocking fibres after the foam is applied to the substrate prior to the drying step.

4. The process of claim 1, wherein the dried foam has a medium foam density of between about 160 g/L and about 1599 g/L.

5-6. (canceled)

7. The process of claim 2, wherein the one or more crosslinkers are selected from the group consisting of polycarbodiimide crosslinker, isocyanate crosslinker, aziridine crosslinker or polyurea crosslinker or a combination thereof

8. The process of claim 7 wherein the one or more crosslinkers is an aqueous polycarbodiimide crosslinkers or 100% solids polycarbodiimide crosslinkers.

9. The process of claim 7 wherein at least one polycarbodiimide crosslinker is present in combination with one or more other types of crosslinkers.

10. The process of claim 1, wherein the one or more flame retardants are present in an amount per coated surface area of between about 20 g/m² and about 80 g/m²₋.

11. (canceled)

12. The process of claim 1, wherein the one or more polyurethane dispersions and the one or more flame retardants are used in the formulation mixture in a ratio of between about 80:20 to about 20:80, where the ratio is based on weights of both component groups.

13. The process according to claim 1, wherein the one or more flame retardants are selected from tris(2-chloroethyl) phosphate (TCEP), tris(1-chloro-2-propyl) phosphate (TCPP), tris(1,3-dichloro-2-propyl) phosphate (TDCP), dimethyl methylphosphonate (DMMP), triethyl phosphate (TEP), triaryl phosphates such as triphenyl phosphate, isopropylphenyl diphenyl phosphate, tricresyl phosphate and trixylenyl phosphate, ammoniumpolyphosphate (APP), stabilized red phosphorus, aluminum hydroxide (ATH), graphite flakes, diphosphates or oligomeric phosphates or phosphonates, diammonium hydrogen phosphate (coated and uncoated), pentabromodiphenyl ether, tetrabromobenzoate ester, tris(butoxyethyl) phosphate, diphenyl octyl phosphate and other diphenyl alkyl phosphates.

14. The process of claim 1 wherein no flame retardant of the intumescent type such as (expandable) graphite is present.

15. The process of claim 1 wherein a flame retardant of the intumescent type such as (expandable) graphite is present in an amount of maximum 20 wt % based on the formulation mixture together with another type of flame retardant.

16. The process of claim 1, wherein the one or more foam stabilizers comprises one or more cationic surfactants, anionic surfactants, or non-ionic surfactants, or combinations thereof.

17. The process of claim 1, wherein the one or more foam stabilizers is a carboxylic acid salt which may be represented by the general formula RCO₂⁻X⁺, where R represents a C₈-C₂₀ linear or branched alkyl, which can contain an aromatic, a cycloaliphatic, or heterocycle; and X is a counter ion such as sodium, potassium or an amine.

18. The process of claim 1, wherein the foam is applied onto the substrate at a coating weight of between about 10 g/m² and about 1000 g/m².

19. (canceled)

20. The process of claim 1, wherein drying is performed at a temperature between about 10° C. and about 170° C.

21. (canceled)

22. The process of claim 1 wherein drying is performed at a first elevated temperature of between about 10° C. and about 100° C followed by drying at a second higher temperature of between about 100° C. and about 120° C.

23-24. (cancel)

25. The process of claim 1, wherein the one or more polyurethane dispersions are aqueous polyurethane dispersions.

26. The process of claim 1 wherein the one or more polyurethane dispersions are aqueous polyurethane dispersions having a solid level of between about 25% to about 65% by weight.

27. (canceled)

28. The process of claim 1, wherein the mechanically foamed mixture is obtained by mechanical stirring at high speeds.

29. The process of claim 1, wherein the substrate is non-rigid.

30. The process of claim 1 wherein the substrate is selected from woven textiles, non-woven textiles, knits, synthetic leather, natural leather, finished natural leather, coated leather, coated polyvinyl chloride, coated non-woven, coated coagulated polyurethane substrates, polypropylene, polyethylene terephthalate, polyolefines, modified polyolefins or laminated structures.

31. The process of claim 1, wherein no fluorochemical is present in the formulation mixture or present in amounts below about 1 wt % of the formulation mixture.

32. A coated substrate made by the process of claim 1.

33. The coated substrate of claim 32 wherein the coating is a pressure resistant dried foam and not a resilient foam.

34. The coated substrate of claim 32 wherein said coated surface passes the requirements of one or more flame tests selected from British Standard BS 5852:2006 specific to upholstered furniture, FAR 25.853 specific for fabrics in aviation, German Standards Fire Resistance test DIN4102 for building materials and elements, British Standard BS 5867-2:2008 for fabrics for fabrics for curtains, drapes and window blinds, French FR Standard NF P 92503-507, fabric FR test for French contract industry (also known as M1).

35. A layered structure of which at least one layer comprises the coated substrate of claim 32.
